(19) United States
(12) Patent Application Publication
(10) Pub. No.: US 2017/0230723 A1
(43) Pub. Date: Aug. 10, 2017

(54) IMPROVED INTERFACE FOR ACCESSING TELEVISION PROGRAMS

(71) Applicant: MOLOTOV, Paris (FR)

(72) Inventor: Jean David Blanc, Paris (FR)

(21) Appl. No.: 15/501,519

(22) PCT Filed: Jul. 22, 2015
(86) PCT No.: PCT/FR2015/052019

§ 371 Date: Feb. 3, 2017

(30) Foreign Application Priority Data
Aug. 4, 2014 (FR) FR1457555

(51) Int. Cl. H04N 21/482; H04N 21/472; H04N 21/81

(52) U.S. Cl. CPC H04N 21/4821; H04N 21/8133; H04N 21/47217; H04N 21/23109

(57) ABSTRACT

Management of an application for electronically guiding and accessing television programs, comprising the control of a display on a screen of a chronological succession of vignettes associated with respective television programs. Content associated with a same recurring television program is identified, and a common vignette display command for all content associated with said program in a presentation of past or future programs is developed.

### FIELD OF THE INVENTION

The present invention particularly relates to a method implemented by information technology means to generate an interface for accessing television programs.

The object of such an interface is to offer more comprehensiveness in the presentation of programs and associated functionalities, while ensuring satisfactory ergonomics of use.

### PRIOR ART

Programs are often still available for deferred viewing several days after they have been directly broadcast. For example, most programs in France are still available seven days after their broadcast date. Therefore, it is possible to access content that has already been broadcast on a deferred basis, which is commonly called “replay television.”)

Some existing interfaces already present programs that have already been broadcast, as well as programs in progress or future programs on the same screen page. Therefore, it appears in FIG. 1 presenting the prior art that a recurring show (for example a television series S1, or S2, or else recurring shows such as weather forecasts EM1 or entertainment shows EM2 in the example illustrated) may appear several times in the programming schedule (for example at a same time 5 p.m.-7 p.m. every weekday). For example, the television series S1 is represented five times in FIG. 1 for successive episodes:
EP A and EP C (episodes already broadcast before the current date AUJ which is 17 March in the example represented),
EP X (episode currently being broadcast, for example), and
EP T and EP V (episodes planned for later broadcasting on the following days).

In the example from FIG. 1, only content scheduled by a same channel CHA1 is represented.

Therefore it appears that vignettes associated with such content clutter up the programming schedule. In particular, when the schedule presents programs from several television channels at once, with all past programs (over a full week), as well as programs in progress and future programs, at different times of the day, the user of such an interface can find the interface difficult to interpret and navigate.

The present invention attempts to improve the situation.

### PRESENTATION OF THE INVENTION

For this purpose, the invention proposes a method implemented by computer technology means for managing an application serving as an electronic guide to television programs, comprising the control of the display on a screen of a chronological succession of vignettes associated with respective television programs.

In particular, the method comprises the steps of:
identifying content associated with a same recurring television program, and
developing a common vignette display command for all content associated with said program in a presentation of past or future programs.

Therefore, the invention implements a data filter to compact the information to be displayed on a screen, thereby enhancing the interface user experience. This improvement is based on an objective (and not depending on its subjectivity) criterion for a user because less data are displayed, which enables use of the interface to be better controlled.

### EMBODIMENTS OF THE INVENTION

In an advantageous embodiment where the vignettes displayed can be selected by an application user, the selection of the aforementioned common vignette triggers a command to display a list of information respectively relative to the content associated with the same aforementioned program.

Such an embodiment presented below in detail with reference to FIG. 3 enables the data presented in the home screen of the interface to be further compacted and enables more detail to be offered to the user by selecting the common vignette.

The information presented after selecting the common vignette may comprise, for each content, at least a content title, a content broadcast time stamp, and an indication of a television channel broadcasting this content.

In an advantageous embodiment, this information comprises a bookmark indication for each content. In particular, this indication can be selected to mark a content (for example for a program recording function), which then enables access to this content in a corresponding directory, dedicated to the user.

This directory may be, for example, a pane for viewing previously marked content, as will be seen in detail below with reference to FIG. 6.

In particular, content is available in the aforementioned directory following a broadcast start timestamp of this content. Of course, the content cannot be viewed until it is or has been directly broadcast. From the start of its broadcasting, the content can be accessible and appears as such in the aforementioned pane for viewing marked content.

In an advantageous embodiment, the aforementioned information comprises an indication of the general mark of all content. In particular, this general mark indication can be selected to mark all content by a single command, to make all content in a corresponding directory (such as a viewing pane) accessible. Therefore, such an embodiment enables all content associated with a same program to be marked (for example all past and future episodes of the same television series, and even broadcast by several television channels, if applicable), by a single command (for example a single click by the user).

In an embodiment, the application comprises a tool for navigating in time, for a display of program vignettes on screen pages (successive as a function of time), the display of vignettes being arranged depending on the respective program broadcast time stamps. In particular, the aforementioned common vignette is displayed on each screen page if an associated content is (or was) broadcast at a time stamp corresponding to the displayed screen page, and more specifically according to a single past occurrence and/or a single future occurrence per screen page.

The present invention also relates to a computer program, comprising instructions for implementing the above method, when this program is executed by a processor. An example of a flow chart for such a program is illustrated in FIG. 5, discussed below.

The present invention also relates to an electronic guide application server for television programs, comprising information technology means (such as a processor and at least one working memory) for implementing the above method. Such a server is illustrated in FIG. 4 and bears the reference SER.

### PRESENTATION OF FIGURES

Other characteristics and advantages of the invention will appear upon examining the following detailed description and the attached drawings in which:

FIG. 1 illustrates an example of an interface screen for accessing television programs, within the meaning of the prior art;

FIG. 2 illustrates an example of an interface screen for accessing television programs with, according to the invention, a single vignette for a given program, for all past or future occurrences of this program;

FIG. 3 illustrates an embodiment of the invention in which the selection of a single program vignette on the interface screen triggers the display of a list of occurrences associated with this program;

FIG. 4 schematically illustrates a system for implementing the invention, in particular involving an application server SER within the meaning of the invention;

FIG. 5 illustrates the main steps of an example of embodiment of the method according to the invention;

FIG. 6 illustrates a pane for viewing marked content by the implementation of the method according to an embodiment of the invention;

FIG. 7 illustrates an embodiment in which a server within the meaning of the invention manages recording operations ordered by a user.

### DESCRIPTION OF EMBODIMENT EXAMPLES

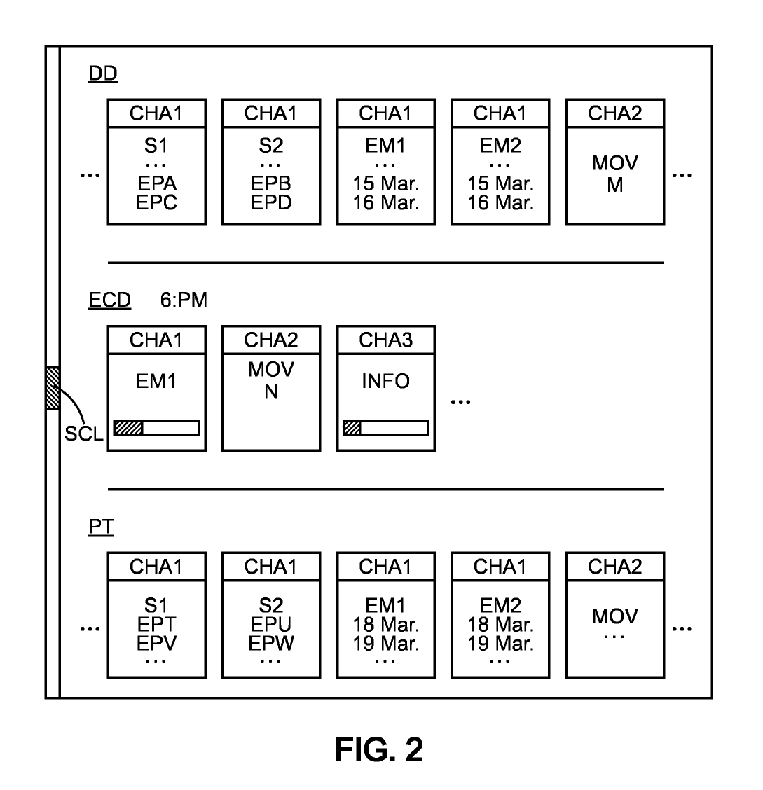

With reference to FIG. 2, the invention proposes presenting all content (present, past and future) broadcast by all channels (CHA1, CHA2, CHA3, etc.) on a same screen page but to only display a single occurrence of a vignette associated with the same recurring show (a same television series S1 or S2, or else a same news show EM1 or entertainment show EM2), and:

in the past DD (programs already broadcast, known as “replay”),

in the present ECD (programs being broadcast), with a scroll bar under the corresponding vignettes, and

in the future PT (programs that will be broadcast later).

In the example from FIG. 2, each vignette displays:

the available content, associated with a same program, such as a series S1, S2, or a show EM1, EM2, which were broadcast in the past DD,

or content associated with a same program (S1, S2, EM1, EM2) that will be broadcast and therefore available in the future PT.

It is possible for a user to navigate in time by scrolling by using the scrolling button SCL or directly by going from one day to another via the temporal menu option of the interface (not represented). The single vignette of a same program appears on each scrolling page if at least one broadcast of a content associated with this program is planned in the observation time range corresponding to the page being displayed. Nevertheless, only a single occurrence of the common vignette is displayed if the screen page only displays past programs or future programs. On the other hand, if the screen page presents both past and future programs as illustrated in FIG. 2, then two occurrences of the same vignette can be present (one for already broadcast content DD, and the other for content broadcast later PT), or even a third occurrence can be present if a content corresponding to this program is being broadcast (ECD).

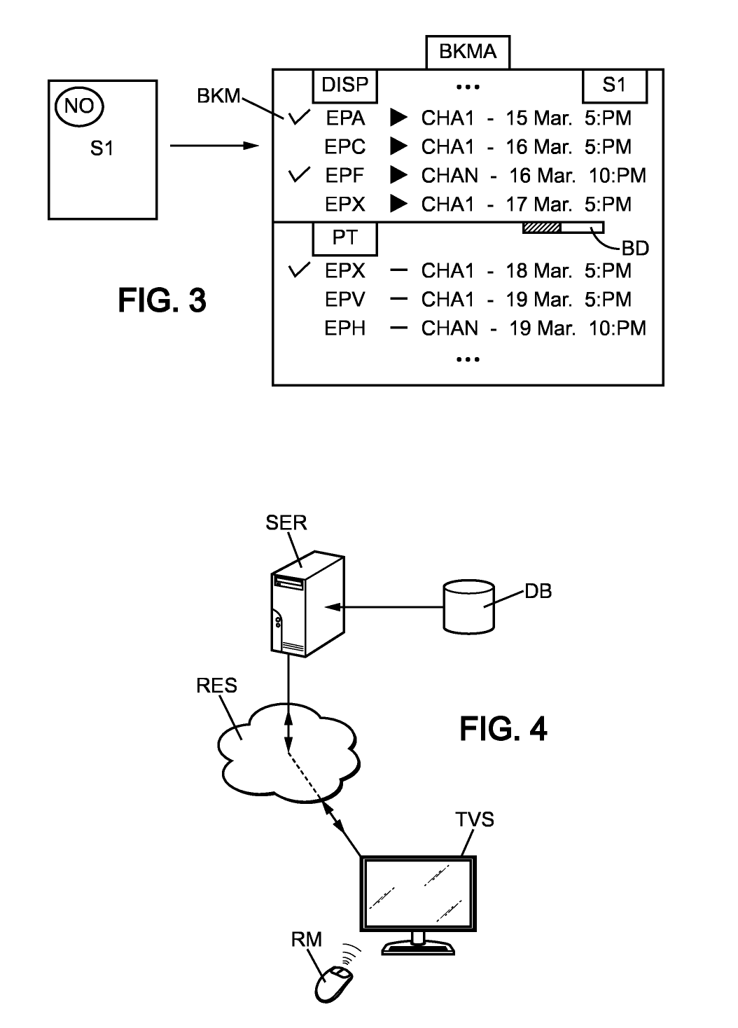

In particular, in the example represented, a single vignette lists the various occurrences of this content. Nevertheless, in an advantageous embodiment, the vignette does not display all occurrences of this program. Therefore, it is possible to display on the vignette of the interface home page other information on the program, for example a thumbnail image as well as the type of program: A series (with the series type, the name of the producer, actors, etc.), or a show, with the show type (entertainment, cooking, fashion, reporting, etc.), or other. Therefore, with reference to FIG. 3, the vignette displays, in addition to this information, the number NO of past and/or future occurrences, of a recurring show (to the left of FIG. 3).

In addition, by selecting this single vignette (for example with a remote control or by double-clicking or right-clicking a mouse), a page describing the show (taking the title and theme for example from the vignette, and adding details on possible actors or hosts, etc.) is displayed (on the right in FIG. 3). This page comprises, in particular, all past, and therefore available, occurrences DISP, and all future occurrences PT, as well as their broadcast date. Thus, a stack of programs from the same recurring show appears on this page. The user therefore has access to, via this list, all already available content (by clicking on the playback button represented by a black triangle). The user also has access to the program being directly broadcast (presented in the list above the scroll bar BD). By selecting this program, the interface proposes resuming content playback from the beginning (with a slight delay), or, on the contrary, continuing direct playback of the content.

In practice, with reference to FIG. 4, a server SER is connected to a database DB listing the programs, broadcast dates and information on the programs, etc. The server can also be connected to a storage memory of content already broadcast or being broadcast. In particular, the database DB is structured by links between interconnected content, such as episodes from a same series, etc. Therefore, a display screen such as a television set TVS, connected directly or via a “decoder” (or set-top box) to the server SER (possibly via an extensive network RES) can display, by the user's request via the remote control RM (or a mouse), the full record relative to a recurring show S1, presenting various past or future occurrences, when the user selects the corresponding vignette.

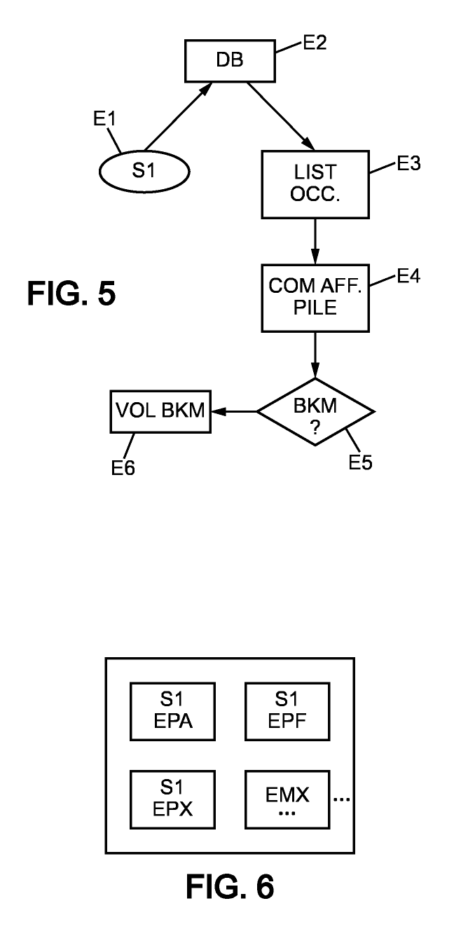

Therefore, in reference to FIG. 5, depending on a given program S1 selected in step E1, the server queries the database DB in step E2 to establish in step E3 a list of occurrences associated with this program and designating content associated with this program, by including information relative to this content (particularly broadcast times). Therefore, the server can send to the set TVS a command to display this list in the form of a stack of information on the content associated with this program S1, in step E4.

It should be noted that database querying is not limited to a specific television channel. Therefore, in the example from FIG. 3, it may be noted that all content associated with a same program S1 is identified, regardless of the channel broadcasting the content (CHA1 or CHAN).

In addition, as it is possible to show future programs in the aforementioned list (for example future episodes of a series), this presentation can display a button to be selected by the user to mark (or record) an occurrence of the program. This application functionality for marking content (or “bookmarking”) enables, in reference to FIG. 6, all content that has been marked in a particular pane to be shown and made available to the user. Therefore, when the broadcast date of this content has passed and the content is therefore available, the user can view such content from this “bookmarks” pane. In reference to FIG. 3 (right part), the user can select content individually to mark it (reference BKM in FIG. 3), or with a particular command, the user can select all content in a single operation. For this purpose, an item in a menu BKMA can be displayed by suggesting a bookmark for all content at once. Therefore, again in reference to FIG. 5, in the event of selecting one or more content(s) to be marked in step E5, marking information is stored in memory in order to display in step E6 the content(s) marked in the bookmark viewing pane.

Therefore, through the functionality associated with this bookmark and later viewing capabilities, the user can schedule a recording of an individual occurrence of the show, but also can schedule, in a single command (for example a single mouse click), a recording of all future occurrences (made available after their direct broadcast date), and more generally still a recording of all occurrences (past and available, in progress and to come). In addition, it is possible to show all past (available in the “bookmark” pane), present and future programs of a given show, regardless of the station broadcasting them, as illustrated in FIG. 6.

In addition, in the case of a recurring program, it is possible to press on differential analysis and recurrence recognition functionalities.

For example, the inventive treatment can, in an embodiment, recognize duplicate shows (for example the same episode of a series regularly rebroadcast on the same channel or on several different channels). Therefore, the aforementioned marking method proposes, in the event of selecting the entire recurring program, a step of analyzing all of the episodes broadcast and only recording the first rebroadcast of each episode by guaranteeing the uniqueness of marked and recorded programs. Saturating a, for example, dedicated bookmark memory (or recording) space for a given user is thus prevented.

Also, for example, it is possible to implement a differential analysis function in relation to already marked content.

Therefore, in the event where the user would only be interested in new episodes of a same program to come (for example new episodes from a same series), a step of analyzing future marking requests with already marked elements is proposed to only record new non-recorded episodes.

The method from the invention thus advantageously comprises a step of identifying and eliminating possible bookmark duplicates, regardless of rebroadcasts on a same channel or on different channels.

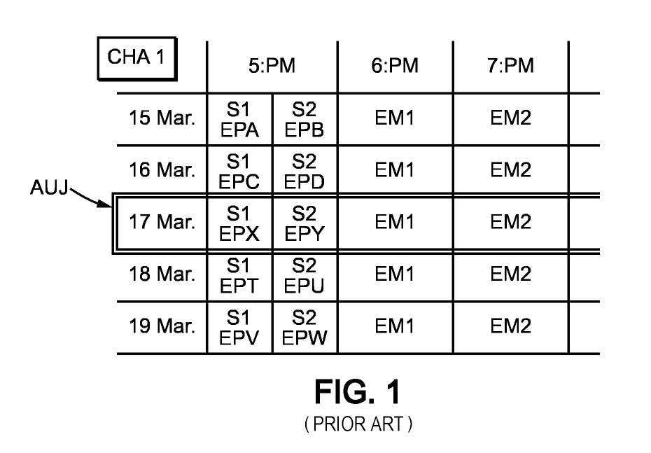

Therefore, it is understood that in a solution from the prior art, all of these past occurrences would have appeared together in a programming schedule (as presented in FIG. 1), thus cluttering up such a schedule. The invention thus overcomes the difficulty in displaying all past and future programs, particularly with recurring shows (weather forecasts from a same channel, even a series broadcast by one or more channels), which, in the prior art, is ponderous and makes selecting programs tedious. By only displaying a single vignette for a past or future show, the invention gathers information on past and future programs in the form of a stack on a same page that is displayed when one of the vignettes for this show is selected (FIG. 3). Such functionality increases the ergonomics of use, particularly when it is possible to select all shows in the stack on a corresponding page to mark all occurrences at the same time (“bookmarks”). This is therefore an advantageous embodiment providing additional technical comfort to the user, according to an objective and not subjective criterion. The invention thus makes a schedule of present, past and future programs more clear, as illustrated in FIG. 2.

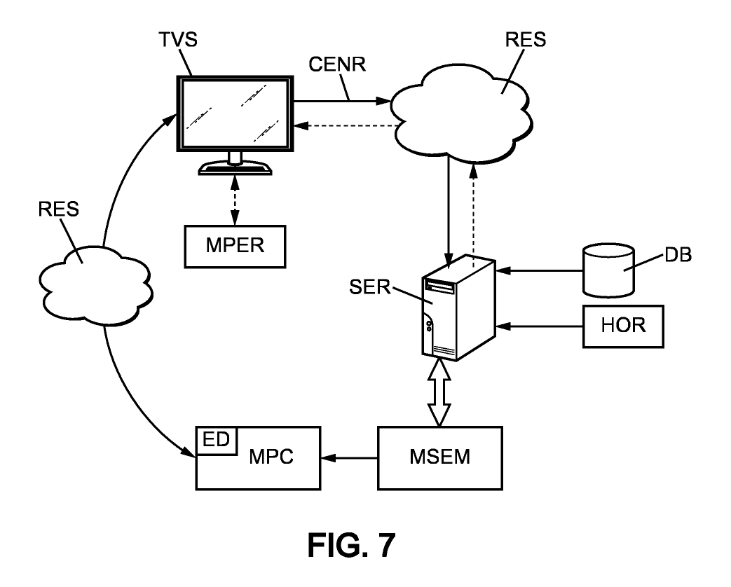

In addition, as indicated previously, the user can schedule a recording in a single command (for example a single mouse click to mark content to be recorded), of all past and/or in progress and/or future occurrences of a show that the viewer particularly wants. Thus, in reference to FIG. 7, according to a possible embodiment of the invention, a mass storage memory MSEM of all content already broadcast (and therefore available, indistinctly) is connected to the server SER. The server SER can then receive and process such a recording command issued from a connected set TVS of a user. In particular, the server SER may carry out such a recording command CENR by:
searching in the mass storage memory MSEM content that has already been broadcast and is available relative to this command, and then storing this content on a user's personal dedicated space ED in a recording memory: this may be a connected memory MPC (in the context of a “cloud” storage application accessible via the network RES, for example), or else a local memory MPER directly available to a user as the latter connects to the network RES via a computer, a connected television set, or other (for example according to a choice by the user),
and by referring to a clock HOR and a program table (issued for example from database DB) to obtain content corresponding to the recording command as soon as it is available immediately following its broadcast, and by storing this content in the user's personal space ED.

For this purpose, the server SER can maintain a list of recording commands for each user and can manage the execution of the above recording operations.

Of course, the present invention is not limited to the embodiments described above by way of example; the invention extends to other variants.

For example, information presented in FIG. 3 relative to each content from the list can be more comprehensive and thus can comprise an indication of the producer of the series or show, actors in the series or show hosts, etc. In addition, database DB requests enable content to be searched by content title, actor or host, etc., key words. Thus, for example, it is possible to also launch commands to record past and/or future programs that have been identified in the context of such a search (by author, actor, or other), as described above in reference to FIG. 7.

In addition, an application for accessing television programs has been described above. Nevertheless, the invention more generally relates to an application serving as an electronic guide to television programs, with access to and saving of, or not, these television programs.

1. A method implemented by computer technology means for managing an application serving as an electronic guide to television programs, comprising the control of a display on a screen of a chronological succession of vignettes associated with respective television programs, wherein the method comprises the steps of:
identifying content associated with a same recurring television program, and
developing a common vignette display command for all content associated with said program in a presentation of past and/or future programs.

2. The method according to claim 1, wherein the displayed vignettes are selectable by an application user and the selection of the common vignette triggers a command to display a list of information respectively relative to the content associated with the same program.

3. The method according to claim 2, wherein information comprise, for each content, at least a content title, a content broadcast time stamp, and an indication of a television channel broadcasting this content.

4. The method according to claim 2, wherein the information comprises a bookmark indication for each content, and wherein said indication is selectable to mark content, for making this content available in a corresponding directory.

5. The method according to claim 4, wherein a content is available in said directory following a content broadcast start timestamp.

6. The method according to claim 2, wherein the information comprises a general mark indication of all content, and in that said general mark indication is selectable to mark all content by a single command, for making all content available in a corresponding directory.

7. The method according to claim 1, wherein the application comprises a tool for navigating in time, for a display of program vignettes on screen pages, arranged according to the respective broadcast timestamps of the programs, and wherein said common vignette is displayed according to a single past and/or single future occurrence per screen page.

8. The method according to claim 6, comprising the steps of:
indistinctly recording in a mass storage memory all content already broadcast,
upon receipt of a command to record all past, present or future marked content, searching in the mass storage memory for already broadcast content relative to said recording command, and storing this content on a user's personal dedicated space in a recording memory;
and referring to at least one timestamp to obtain content corresponding to said recording command as soon as it is available after broadcasting, to store this content in said user's personal space;
recording programs by guaranteeing their uniqueness in the personal space with elimination of duplicates and recognizing new non-recorded programs by differential analysis.

9. The method according to claim 8, wherein the personal dedicated space is accessible via a cloud application.

10. The method according to claim 8, wherein the personal dedicated space is accessible in a local memory available to the user.

11. The method according to claim 6, comprising a step of identifying and eliminating duplicated marked content.

12. A non-transitory computer storage medium storing a computer program, the program comprising instructions for implementing the method according to claim 1, when the program is executed by a processor.

13. An application server serving as an electronic guide for television programs, the server comprising means for implementing the method according to claim 1.
